(19) United States
(12) Patent Application Publication
(10) Pub. No.: US 2009/0233547 A1
(43) Pub. Date: Sep. 17, 2009

(54) CRADLE FOR A MEDIA PLAYER

(75) Inventors: Sze Hian Ong, Singapore (SG); Wong Hoo Sim, Singapore (SG); Hiap Chew Chua, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 11/721,329

(22) PCT Filed: Dec. 12, 2005
(86) PCT No.: PCT/SG2005/000415

§ 371 Date: Jun. 8, 2007

(30) Foreign Application Priority Data
Dec. 13, 2004 (SG) 200407421-7

(51) Int. Cl. H04B 7/24

(52) U.S. Cl. 455/41.2

(57) ABSTRACT

A cradle for a media player is provided. The cradle comprises a base and at least one side wall extending upwardly from the base and extending around the periphery of the base. The base and the at least one side wall define a hollow interior for releasably receiving therein the media player. The cradle also has a retainer for assisting in releasably retaining the media player in the hollow interior, and a signal receiver for receiving a media signal from the media player when the media player is in the hollow interior and in a reproduction mode. An antenna in the cradle is for receiving the media signal from the signal receiver and transmitting the media signal by use of a wireless system for enabling reproduction of the media signal by a wireless-enabled reproduction apparatus.

### FIELD OF THE INVENTION

This invention relates to a cradle for a media player and refers particularly, though not exclusively, to a cradle for a media player for enabling a wireless connection with a media reproduction apparatus.

### BACKGROUND OF THE INVENTION

Media players such as, for example, portable MP3 players, normally require a physical connection between the player and a reproduction apparatus for the media to be reproduced. For example, an MP3 player can be physically connected to a host computer, speakers, or like system to enable the audio to be sent to the host and thus the audio reproduced by the host. Alternatively, headphones or the like can be physically connected to the player and the audio reproduced using the headphones.

There is no facility for wireless connectivity for such players.

### SUMMARY OF THE INVENTION

In accordance with a first aspect there is provided a cradle for a media player, the cradle comprising a base and at least one side wall extending upwardly from the base and extending around the periphery of the base. The base and the at least one side wall define a hollow interior for releasably receiving therein the media player. A retainer is provided for assisting in releasably retaining the media player in the hollow interior. The cradle has a signal receiver for receiving a media signal from the media player when the media player is in the hollow interior and in a reproduction mode. The cradle also has an antenna for receiving the media signal from the signal receiver and transmitting the media signal by use of a wireless system for enabling reproduction of the media signal by a wireless-enabled reproduction apparatus.

The at least one side wall may have an opening therethrough for enabling access to at least one function of the media player when the media player is in the hollow interior. The opening may extend into the base for enabling the passage therethrough of a finger for assisting removal of the media player from the cradle. The retainer may extend across a part of the hollow interior. The retainer may extend from a first end wall of the plurality of side walls towards a second, opposite end wall; and between two opposed and parallel side walls.

The signal receiver may be an input for wirelessly receiving the media signal from an output of the media player when the media player is in the hollow interior and in the reproduction mode. The wireless reception may be one of: wireless induction, radio frequency, and infrared transmission. Alternatively, the signal receiver may be a jack mounted to the at least one side wall for engaging a headphone socket of the media player.

The at least one side wall may have mounted thereon a seal, the seal being mounted on an internal surface of the at least one side wall adjacent an upper periphery thereof for assisting in releasably retaining the media player in the hollow interior in the manner of a snug fit.

The cradle may further comprise a clip attached to the base for enabling the releasable attachment of the cradle to a support. The clip may be releasably attached to the base.

The cradle may further comprise a converter for converting an analog media signal to a digital media signal.

According to a second preferred aspect there is provided a method of transmitting an output from a media player to a wireless-enabled reproduction apparatus. The method comprises inserting the media player into a hollow interior of a cradle and placing the media player into a reproduction mode. The output of the media player is sent from the media player to a signal processing system forming a part of the cradle. The signal processing system of the cradle receives the output of the media player and wirelessly sends the output to the reproduction apparatus.

The signal processing system of the cradle may comprise an input for wirelessly receiving output of the media player, the wirelessly receiving being selected from wireless induction, radio frequency, and infrared transmission.

Alternatively, the signal processing system may receive the output of the media player as an analog output and converts the analog output to a digital output before sending the digital output to the reproduction apparatus.

### BRIEF DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawings in which:

FIG. 1 is an illustration of an example of an existing system for media reproduction;

FIG. 2 is a top perspective view of a preferred embodiment;

FIG. 3 is an underneath perspective view of the preferred embodiment;

FIG. 4 is a side view of the preferred embodiment;

FIG. 5 is a partial cross sectional view is an enlarged scale along the lines and in the direction of arrows 5-5 on FIG. 4;

FIG. 6 is a partial cross-sectional view along the lines and in the direction of arrows 6-6 or FIG. 4 but of an alternative embodiment;

FIG. 7 is a perspective view of a media player in the preferred embodiment;

FIG. 8 is a block diagram of both the preferred and alternative embodiments; and

FIG. 9 is a flow chart for the operation of the preferred embodiment.

### DETAILED DESCRIPTION OF THE PREFERRED EMBODIMENTS

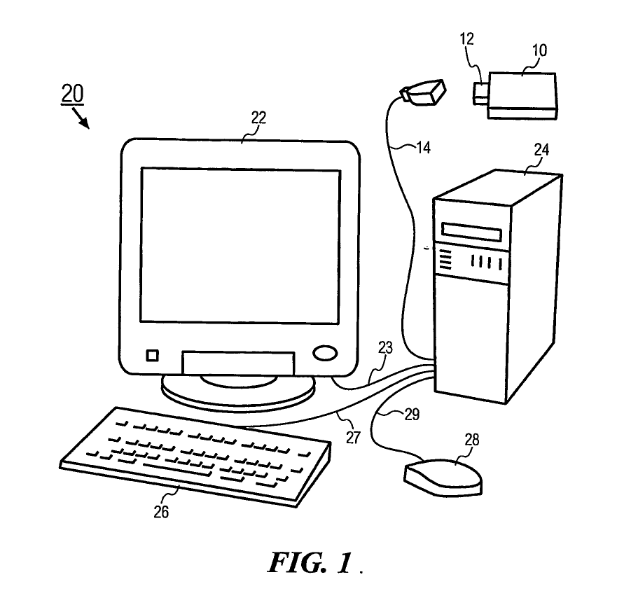

To first consider FIG. 1, there is shown a media player 10 such as an MP3 player. It is able to be connected to a computer system generally shown as 20 by a USB connector 12 of the player 10 or, if player 10 does not have a connector 12, by use of a USB cable 14 able to connect to the player 10 and the computer system 20. The computer system 20 is not limiting and may be an amplified, powered speaker system, automobile sound system, headphones, or other form of media reproduction. Furthermore, the USB connection may be of any other suitable physical connection such as, for example, IEEE 1394.

The computer system 20 has a monitor 22, processor 24, keyboard 26 and mouse 28. The monitor 22, keyboard 26 and mouse 28 are connected with processor 24 by cables 23, 27 and 29 respectively.

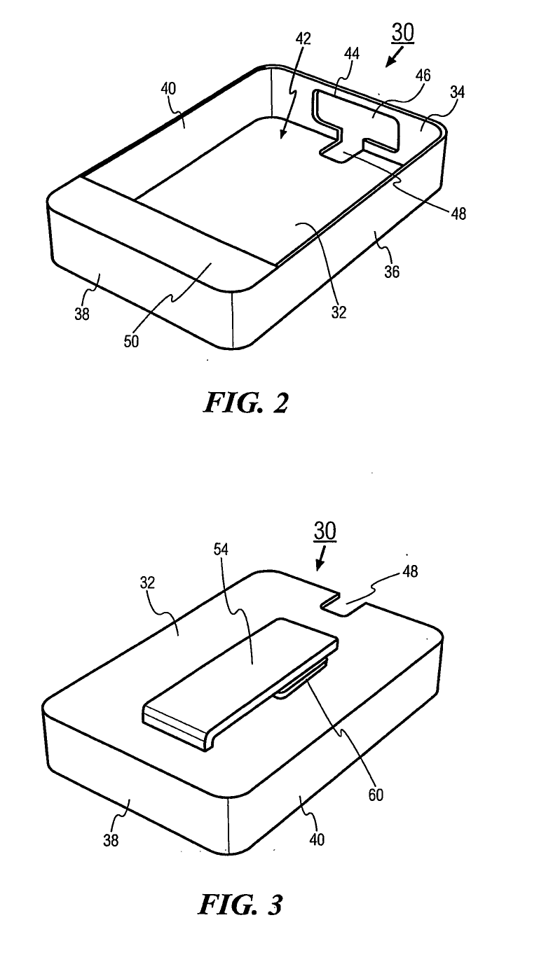

To refer now to FIGS. 2 to 5, there is shown a cradle 30 having a base 32, four mutually perpendicular side walls 34, 36, 38, 40 extending around the periphery of base 32 and extending generally upwardly therefrom. The base 32 and side walls 32, 36, 38, 40 define a hollow interior 42 into which the player 10 may be releasably inserted. The size and shape of base 32 and walls 34, 36, 38 and 40, is intended to closely match the size, and shape of player 10 such that when player 10 is in the hollow interior 42 of cradle 30 it substantially fills hollow interior 42 in the manner of a snug fit.

At one end wall 34 there is a generally T-shaped opening 44 through wall 34 and base 32. The portion 46 of opening 44 through wall 34 is to align with functional controls and/or connection plugs and/or sockets of player 10 to enable access to them when player 10 is in cradle 30. The portion 48 of opening 44 through base 32 is to enable a projection (such as human finger) to pass therethrough to assist in removing player 10 from cradle 30.

At the other end 38 (the end opposition end 34) there is provided a retainer 50 extending between side walls 36, 40 and from end wall 38 towards end wall 34. The retainer 50 partially covers hollow interior 42 and serves to assist in retaining player 10 in cradle 30.

Around the upper, internal periphery of side walls 34, 36, 38, 40 is a seal 52 that also assists in retaining player 10 in the cradle 30, and that provides protection to both cradle 30 and player 10 during the insertion into and removal from cradle 30 of player 10.

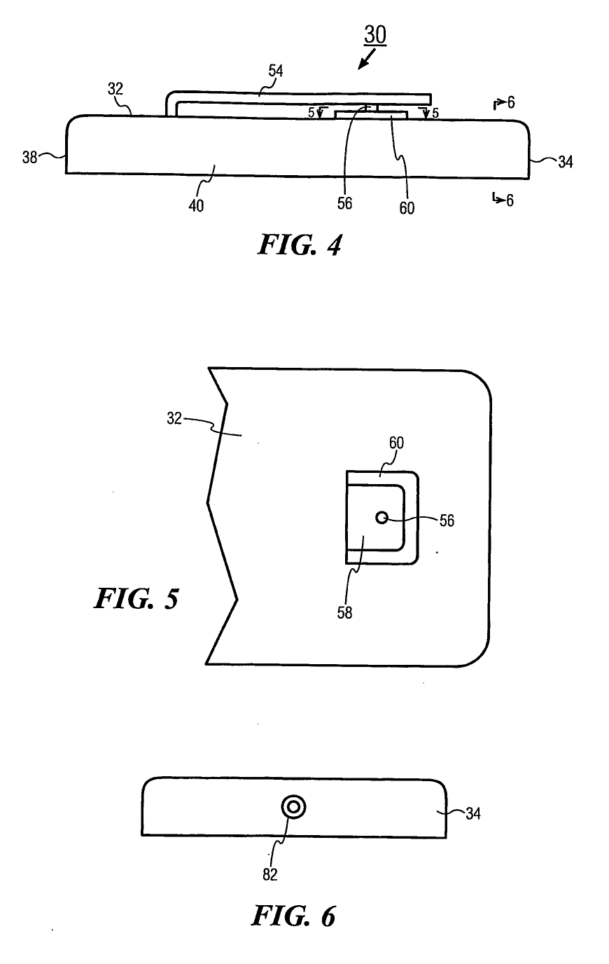

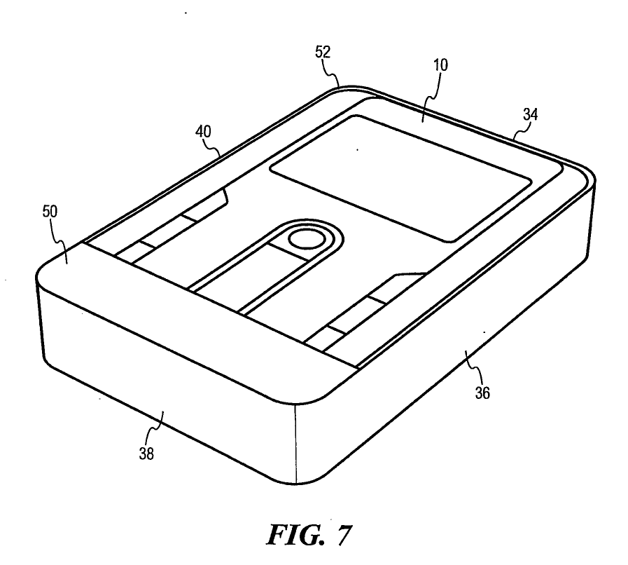

Mounted underneath base 32 is a holding clip 54 that is biased to the position shown in FIGS. 3 and 4. The clip 54 is mounted on a stem 56 for pivotal movement about stem 56 to enable clip 54 to be opened for enabling cradle 30 to be releasably attached to, for example, a belt or the like of a user. Stem 56 is mounted to or integral with a base plate 58 that is preferably securely yet releasably received in a generally U-shaped mounting 60 that is in turn securely attached to or integral with base 32.

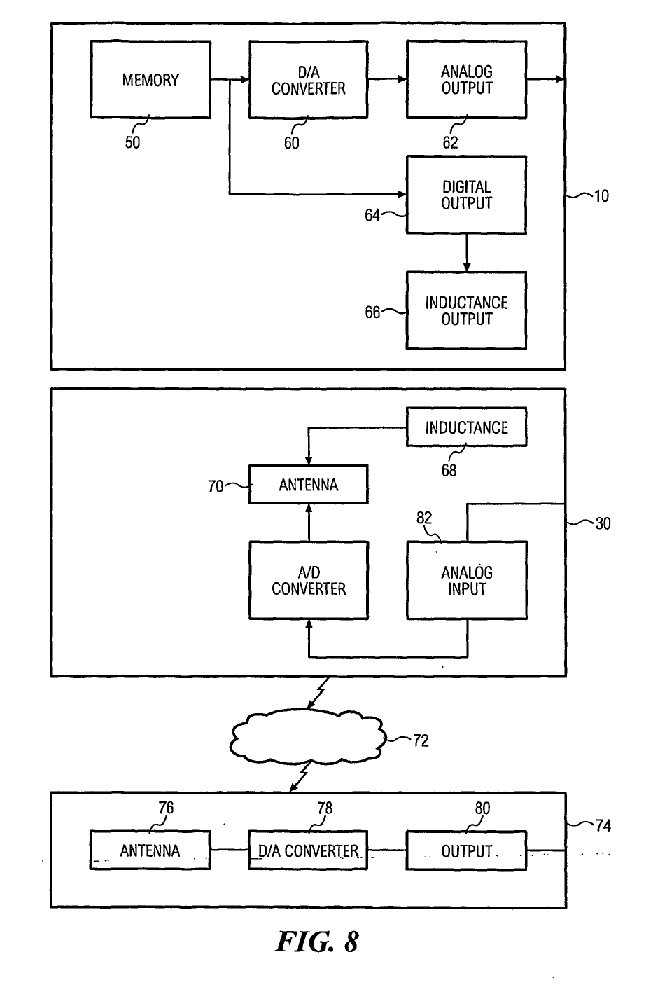

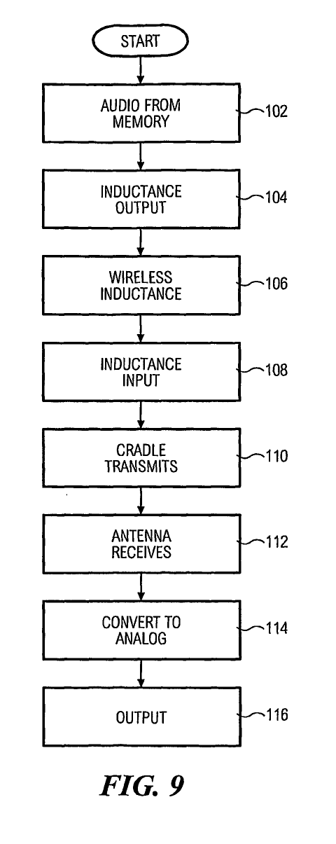

FIG. 8 schematically shows the principal components in the signal processing system when the player 10 is an MP3 player and is inserted in cradle 30 and fills hollow interior 42. For the sake of simplicity many components (e.g. controllers) have been omitted. The general operation is shown is FIG. 9. However, other forms of media players may be used such as, for example, audio/visual players.

In player 10 there is a non-volatile memory 58 operatively connected to a digital-to-analog converter 60 that provides an analog output 62 normally in the form of a headphone socket. In this way digital audio from the memory 58 (102) is converted in converter 62 passed to output 64 (104). Unconverted digital audio is output at 64 by use of wireless inductance output 66 (104) and is passed by wireless induction (106) to cradle 30.

Cradle 30 has an inductance input 68 that, when in close proximity to inductance output 66, will receive the digital audio signal 64 (108) and pass it to an antenna 70 for transmission wirelessly 72 (140) to a reproduction apparatus 74 such as, for example, wireless enabled headphones computer 20, or the like. The wireless transmission 72 may be by use of any suitable system including, but not limited to, Bluetooth, WiFi, WiFiMax, and so forth. Rather than wireless induction, radio frequency or infrared transmission may be used.

Upon the signal 64 being received at apparatus 74 it is received by antenna 76 (112), converted from digital to analog by digital to-analog converter 78 (114) and output as an analog signal 80 (116). The signal 64 may be other than audio. For example, it may be audio/visual, image data such as photographs or streaming video, or remote control commands. The nature of the signal will depend on the nature of the media player 10.

Alternatively, and as shown in FIGS. 6 and 8, cradle 30 may have mounted therein a jack 82 for engaging in a headphone socket 62 of player 10 for providing an analog audio input to cradle 30. The analog input 82 is then converted to digital in analog-to-digital converter 84 and the digital audio passed to antenna 70. In other respects the system is the same as described above.

Whilst there has been described in the foregoing description preferred embodiments of the present invention, it will be understood by those skilled in the technology that many variations or modifications in details of design or construction or operation may be made without departing from the present invention.

1. A wireless cradle for a media player, the cradle comprising:
(a) a base;
(b) at least one side wall extending upwardly from the base and extending around the periphery of the base;
(c) the base and the at least one side wall defining a hollow interior for releasably receiving therein the media player;
(d) a retainer for assisting in releasably retaining the media player in the hollow interior;
(e) a signal receiver for receiving a media signal from the media player when the media player is in the hollow interior and in a reproduction mode; and
(f) an antenna for receiving the media signal from the signal receiver and transmitting the media signal by use of a wireless system for enabling reproduction of the media signal by a wireless-enabled reproduction apparatus,
wherein the signal receiver for receiving the media signal is selected from the group consisting of: a wireless input receiver and a jack mounted to the at least one side wall for engaging a headphone socket of the media player.

2. A wireless cradle as claimed in claim 1, wherein the at least one side wall has an opening there through for enabling access at least one to function of the media player when the media player is in the hollow interior.

3. A wireless cradle as claimed in claim 2, wherein the opening extends into the base for enabling the passage therethrough of a finger for assisting removal of the media player from the cradle.

4. A wireless cradle as claimed in any one of claims 1 to 3, wherein the retainer extends across a part of the hollow interior.

5. A wireless cradle as claimed in any one of claims 1 to 4, wherein the wireless input receiver receives the media signal from an output of the media player when the media player is in the hollow interior and in the reproduction mode; the wireless reception being enabled by systems selected from the group consisting of: wireless induction, radio frequency, and infrared transmission.

6. A wireless cradle as claimed in any one of claims 1 to 5, wherein the at least one side wall has mounted thereon a seal, the seal being mounted on an internal surface of the at least one side wall adjacent an upper periphery thereof for assisting in releasably retaining the media player in the hollow interior in the manner of a snug fit.

7. A wireless cradle as claimed in any one of claims 1 to 6 further comprising a clip attached to the base for enabling the releasable attachment of the cradle to a support.

8. A wireless cradle as claimed in claim 7, wherein the clip is releasably attached to the base.

9. A wireless cradle as claimed in any one of claims 1 to 8, wherein the retainer extends from a first end wall of the plurality of side walls towards a second, opposite end wall; and between two opposed and parallel side walls.

10. A wireless cradle as claimed in any one of claims 1 to 9 further comprising a converter for converting an analog media signal to a digital media signal.

11. A method of transmitting a media signal output from a media player to a wireless-enabled reproduction apparatus, the method comprising:
(a) inserting the media player into a hollow interior of a wireless cradle;
(b) placing the media player into a reproduction mode;
(c) the media signal output of the media player being sent from the media player to a signal processing system forming a part of the wireless cradle;
(d) the signal processing system of the wireless cradle receiving the media signal output of the media player and wirelessly sending the media signal output to the reproduction apparatus,
wherein the media signal output of the media player is received either wirelessly or through a physical connection.

12. A method as claimed in claim 11, wherein the wireless reception of the media signal output of the media player is enabled by systems selected from the group consisting of: wireless induction, radio frequency, and infrared transmission.

13. A method as claimed in either claim 12 or claim 13, wherein the signal processing system receives the media signal output of the media player as an analog output and converts the analog output to a digital output before sending the digital output to the reproduction apparatus.

14. A method as claimed in any one of claims 11 to 13, wherein the wireless cradle is as claimed in any one of claims 1 to 13.
